(19) United States
(12) Patent Application Publication
(10) Pub. No.: US 2009/0208296 A1
(43) Pub. Date: Aug. 20, 2009

(54) DROP MASS SOIL COMPACTION APPARATUS

(75) Inventors: Eric Johnstone Cook, Nigel (ZA); Johannes Abraham Beukes, Heidelberg (ZA)

Correspondence Address: MORGAN, LEWIS & BOCKIUS LLP (SF), One Market, Spear Street Tower, Suite 2800, San Francisco, CA, 94105, US

(73) Assignee: Compaction Technology (Proprietary) Ltd., Nigel (ZA)

(21) Appl. No.: 11/720,423

(22) PCT Filed: Nov. 22, 2005
(86) PCT No.: PCT/IB2005/003490

§ 371 Date: Feb. 13, 2009

(30) Foreign Application Priority Data
Nov. 29, 2004 (ZA) 2004/9626

(51) Int. Cl. E02D 3/02; G01S 1/00

(52) U.S. Cl. 405/271; 342/357.09

(57) ABSTRACT

The invention concerns a drop mass soil compaction apparatus (10, 50) which has a supporting frame (12,64) and a mass (20, 76) which can be raised relative to the frame to an elevated position above a soil surface (40, 61) which is to be compacted. The apparatus includes a mass lifting arrangement for raising the mass to the elevated position such that when the mass is subsequently dropped from such position it impacts on the soil surface in order to compact it. The mass lifting arrangement includes a flexible cable (24, 92) attached to the mass and an hydraulic or pneumatic actuator (36, 68) which is carried by the supporting frame and which acts on the cable in a manner to raise the mass. The cable effectively isolates the mass lifting arrangement, and in particular the actuator, from shock loads generated by impacts of the mass on the soil surface.

### BACKGROUND TO THE INVENTION

THIS invention relates to a drop mass soil compaction apparatus.

There are numerous applications where it is necessary to compact a relatively small area of soil but where the use of conventional soil compaction machinery, typically employing rollers of one type or another, is inappropriate. One example is in the compaction of soil adjacent bridge abutments, where limited space makes it impossible to compact with conventional large rollers or other machines. Another example is in the compaction of soil in trenches for pipes, strip foundations or the like. Yet another example is in road maintenance where local failure of a section of a road may have taken place in a relatively small area.

Although small vibratory rollers and impactors are available and are widely used in such applications, the level of soil compaction and the depth of compaction influence which can be achieved with such devices is limited. The result is often that undue settlement and or structural failure can take place after a relatively short period of time.

It has been proposed to use drop mass soil compaction to achieve compaction of soil in the kind of situations envisaged above. In drop mass compaction, a substantial mass is repeatedly raised and dropped to apply impacts to the soil surface for the purposes of compacting it. In a conventional drop mass soil compactor, as described for instance in WO 00/28145, an hydraulic actuator carried by a mast structure is connected directly to the mass and is operable to raise the mass in preparation for each impact. When the mass has been raised to the appropriate height it is dropped and this requires rapid extension of the hydraulic cylinder. The impact imposes severe stresses on the cylinder and its supporting structure, and this can lead to rapid wear and early failure of the apparatus.

### SUMMARY OF THE INVENTION

According to the present invention there is provided a drop mass soil compaction apparatus comprising a supporting frame, a mass which can be raised relative to the frame to an elevated position above a soil surface which is to be compacted, and mass lifting means for raising the mass to the elevated position such that when the mass is subsequently dropped from such position it impacts on the soil surface in order to compact it, wherein the mass lifting means comprising a flexible cable attached to the mass and an hydraulic or pneumatic actuator carried by the supporting frame and operable to act on the cable in a manner to raise the mass.

In this specification, the term “cable” is used in a broad sense to refer to any suitable, elongate element, and includes elements such as ropes and the like.

Preferably one end of the cable is anchored relative to the supporting frame and an opposite end of the cable is connected to the mass, with the cable acting to isolate the mass lifting means from shock loads generated by impacts of the mass on the soil surface.

In the preferred embodiments, the apparatus comprises respective pulley blocks each including one or more pulleys around which the cable passes, at least one of the pulley blocks, on which the actuator acts, being vertically movable.

The arrangement of cable and pulleys is typically such that the actuator acts at a mechanical disadvantage to raise the mass at a velocity advantage.

Other features of the invention are set forth in the appended claims.

### BRIEF DESCRIPTION OF THE DRAWING

The invention will now be described in more detail, by way of example only, with reference to the accompanying drawings in which:

FIG. 1 shows a perspective view of a drop mass soil compaction apparatus according to a first embodiment of the invention;

FIG. 2 shows a perspective view of a drop mass soil compaction apparatus according to a second embodiment of the invention;

FIG. 3 shows a side view of the apparatus seen in FIG. 2;

FIG. 4 shows a rear view of the apparatus seen in FIG. 2;

FIG. 5 shows a cross-sectional view at the line 5-5 in FIG. 3;

FIG. 6 shows a cross-sectional view at the line 6-6 in FIG. 3;

FIG. 7 shows a cross-sectional view at the line 7-7 in FIG. 3; and

FIG. 8 diagrammatically illustrates the route followed by the cable in the embodiment of FIG. 2.

### DESCRIPTION OF THE ILLUSTRATED EMBODIMENTS

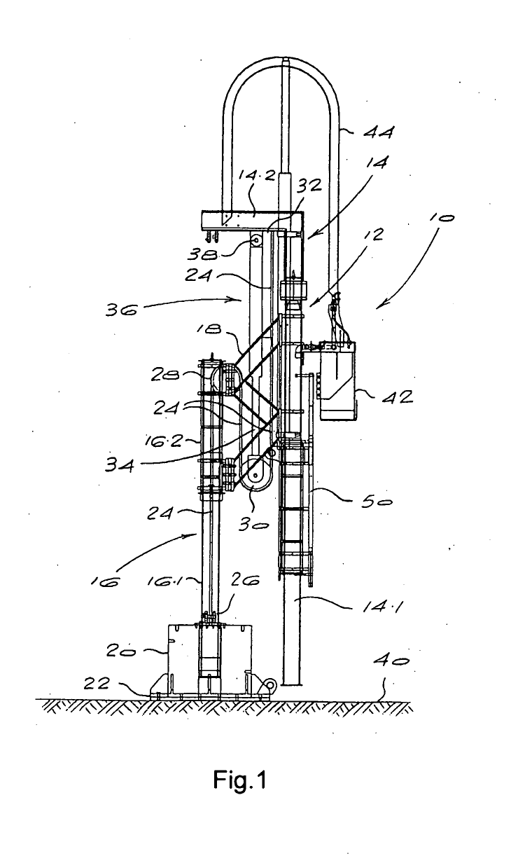

FIG. 1 illustrates a first embodiment of drop mass soil compaction apparatus according to the invention. In this Figure, the apparatus 10 is shown in an operative, upright position. The terms vertical, horizontal, upright and so on refer to the apparatus at the illustrated orientation.

The apparatus 10 has a supporting frame 12 including a mast 14 and a support member 16 connected rigidly to one another by diagonal braces 18. The mast 14 consists of a vertical column 14.1 and a beam 14.2 which cantilevers horizontally from the upper end of the column.

The apparatus 10 also includes a mass 20 having a flat footplate 22. The mass is arranged to slide up and down a lower section 16.1 of the member 16. One end of a flexible cable 24 is attached to the mass at a point 26. The cable extends upwardly inside the section 16.1, through an upper section 16.2 of the member 16 and over a first pulley 28 mounted on the member 16. The cable then passes beneath a second pulley 30 and finally extends upwardly to a point 32 at which it is attached to the beam 14.2.

The pulley 30 is attached to the piston 34 of an hydraulic cylinder or actuator 36. The cylinder of the actuator 36 is attached to the beam 14.2 at a point 38. It will be understood that extension of the actuator pushes the pulley 30 down with the result that the mass 20 is lifted upwardly on the section 16.1 of the member 16. It will also be understood that the actuator lifts the mass at a mechanical disadvantage, i.e. the force with which the actuator must drive the pulley 30 downwardly is greater, in the illustrated case by a factor of two, than the weight of the mass, and that the velocity at which the actuator extends is half the velocity at which the mass is lifted, i.e. there is a velocity advantage which enables the mass to be lifted rapidly.

The operation of the actuator is controlled by a PLC (programmable logic controller 42. Control wires extend from the PLC to the cylinder via an arched cable guide 44. More is said subsequently about the PLC and the controls which it offers.

At the position shown in the drawing, the mass 20 rests on a soil surface 40 which is to be compacted. When the mass has been lifted to a predetermined design elevation above the surface 40, the actuator 36 is rapidly depressurized under the control of the PLC and the mass is allowed to drop freely under gravity for the footplate 22 to impact on the soil surface 40. The procedure can then be repeated as necessary to achieve desired levels of soil compaction.

The illustrated apparatus is designed as an attachment to an existing vehicle. For this purpose the supporting frame carries an attachment bracket 50 which can mate with a cooperating bracket on the vehicle. The vehicle may for instance be an earthworking machine such as a front end loader, mechanical shovel, backacting shovel or the like. In such applications it is the intention that the apparatus can be coupled, as and when needed for soil compaction duties, to a machine which is already on site to perform certain earthworking functions, and that the apparatus can then be detached from the vehicle when no longer needed and other earthworking functions are to be resumed. Alternatively the vehicle could be of a highly manoeuvrable type such a three-wheeled vehicle of the kind traditionally used in log or sugar cane loading duties.

The PLC may be pre-programmed with one or more soil properties which it is desired to achieve. These may for instance include the soil stiffness, strength, bearing capacity or settlement. Indications of one or more of these parameters may be attained via a sensor attached to the mass 20 to measure the velocity of the mass or the deceleration thereof as it impacts the soil surface. In the latter case the deceleration of the mass as it impacts the soil surface may be used to give an indication of the instantaneous level of soil stiffness which in turn provides a reliable indication of the instantaneous level of compaction of the soil. In this application, the PLC may for instance be pre-programmed to achieve a predetermined level of soil compaction and, in accordance with the programme may control variable parameters such as the number of impact blows which are to be applied, the energy to be applied to the soil surface at each impact (this being a function of the height to which the mass is lifted prior to each impact) and/or the frequency of the impacts. Depending on the parameters which are to be controlled, the apparatus of the invention may also include various items of ancillary equipment. For instance, where impact energy is to be controlled, the member 16 may be fitted with proximity sensors to sense the vertical position of the mass and to feed relevant information in this regard to the PLC which can, on the basis of such information, then control the operation of the actuator.

The PLC may also be interfaced with a GPS (global positioning system) so that measurements of soil properties, such as soil stiffness, can be correlated automatically with geographical position. The apparatus may, as indicated previously, be used in localized areas to provide specific levels of compaction in those areas. However it is also possible to use the apparatus to compact soil over larger areas, particularly when the apparatus is coupled to a vehicle capable of traversing the site. In the latter situation, where the apparatus is used to compact an entire site or different areas on a site, it is then possible to generate automatically a site plan on which levels of soil compaction across the site or at different areas on the site are presented. The results can be presented graphically or digitally or even as a pre-prepared document certifying levels of soil compaction.

Mention has been made of the illustrated apparatus being attachable when required to a vehicle. It is however also within the scope of the invention for the apparatus to be mounted permanently on a vehicle.

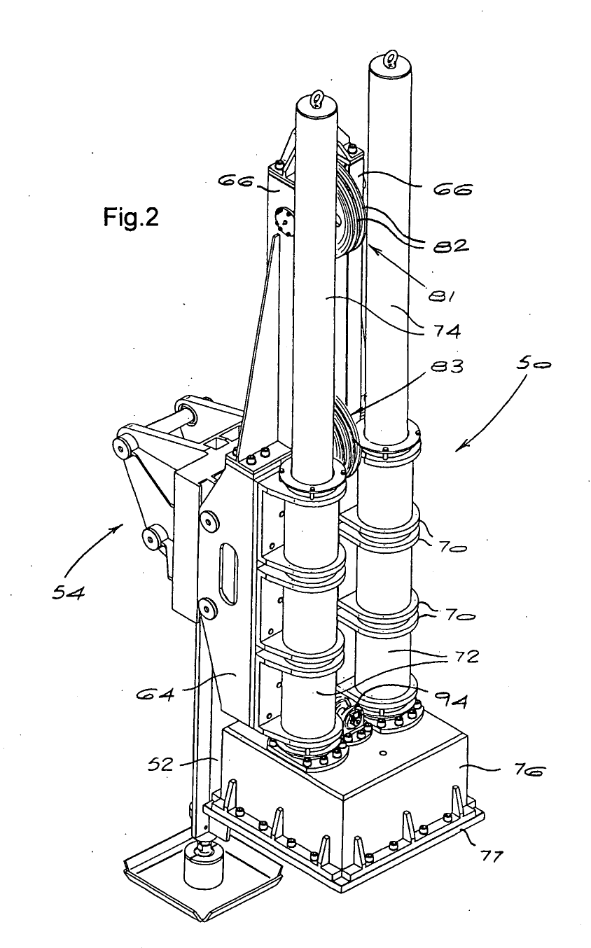

FIGS. 2 to 7 illustrate a second, currently preferred embodiment of the invention. The drop mass soil compaction apparatus 50 seen in these Figures has a member 52 extending downwardly from a three-point hitch bracket 54 by means of which the compaction apparatus can be mounted to a vehicle, such as one of those mentioned previously. A vertical, telescopic outrigger strut 56 is attached to the member 52 and carries, at its lower end, a bearing plate 60. In use, with the apparatus coupled to a vehicle via the hitch bracket the outrigger can be telescoped as necessary for the bearing plate 60 to bear on the soil surface 61, thereby stabilising the apparatus during soil compaction. The bearing plate 60 is connected to the outrigger at a ball coupling 62 which allows it to swivel as necessary to adapt to the contour of the soil surface on which it acts.

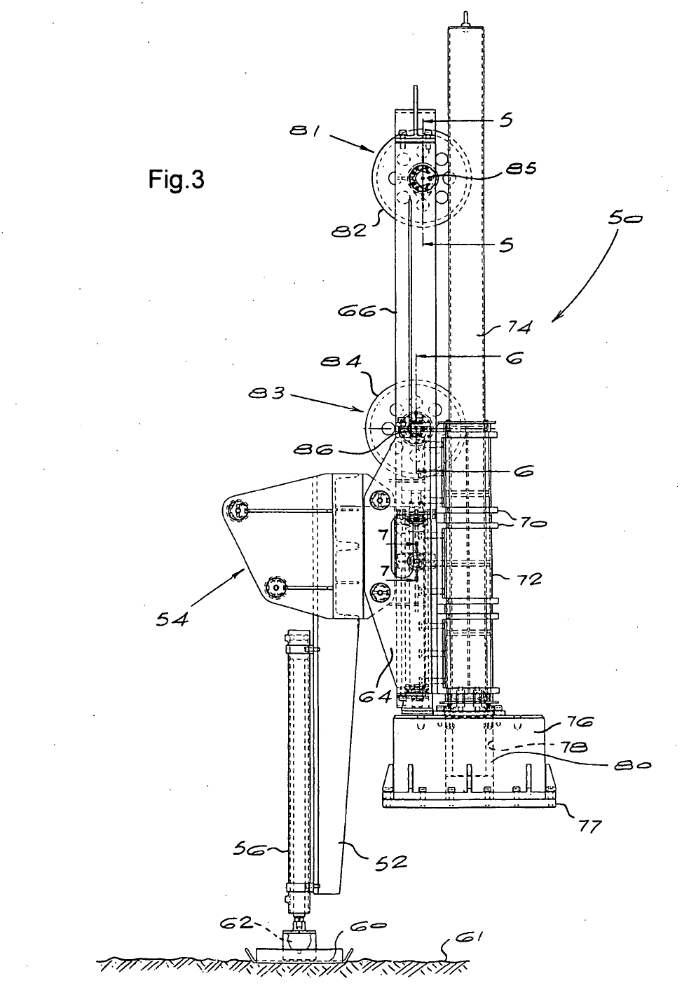

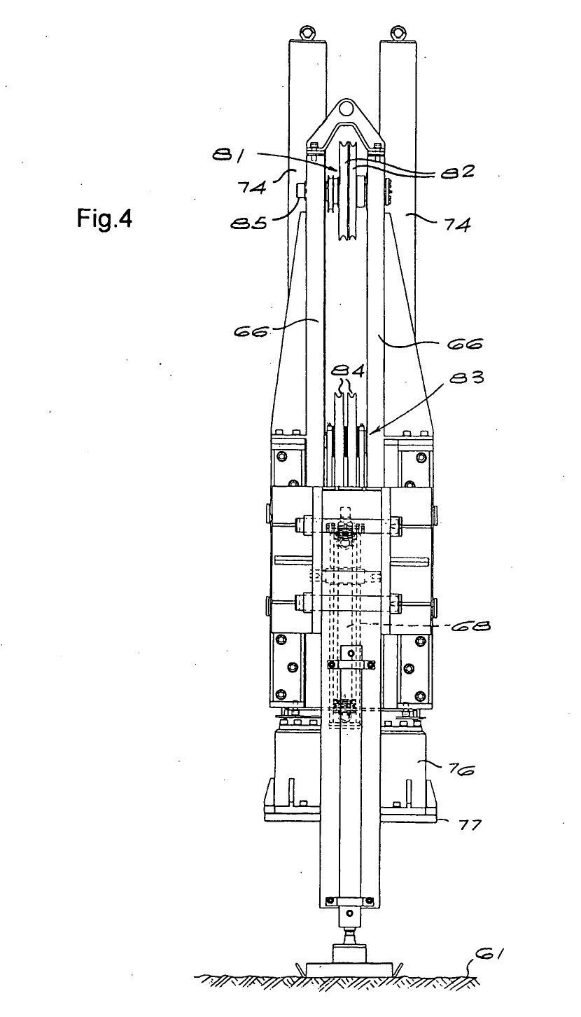

The hitch bracket 54 extends laterally from a frame 64 including a pair of spaced apart, opposing, channel-section guide posts 66. As shown in FIG. 4, the frame 64 supports a vertically oriented hydraulic actuator 68. The frame 64 also carries a series of laterally extending brackets 70 having vertically aligned openings through which tubular guides 72 extend vertically. The guides 72 serve to guide the vertical movement of posts 74 which pass through the guides 72 and which are connected at their lower ends to a compaction mass 76 having a footplate 77. As shown in FIG. 3, the posts 74 locate in sockets 78 in the mass 76 and are surrounded within the mass by shock-absorbing inserts 80 made of a suitable shock-absorbing material such as a polyurethane.

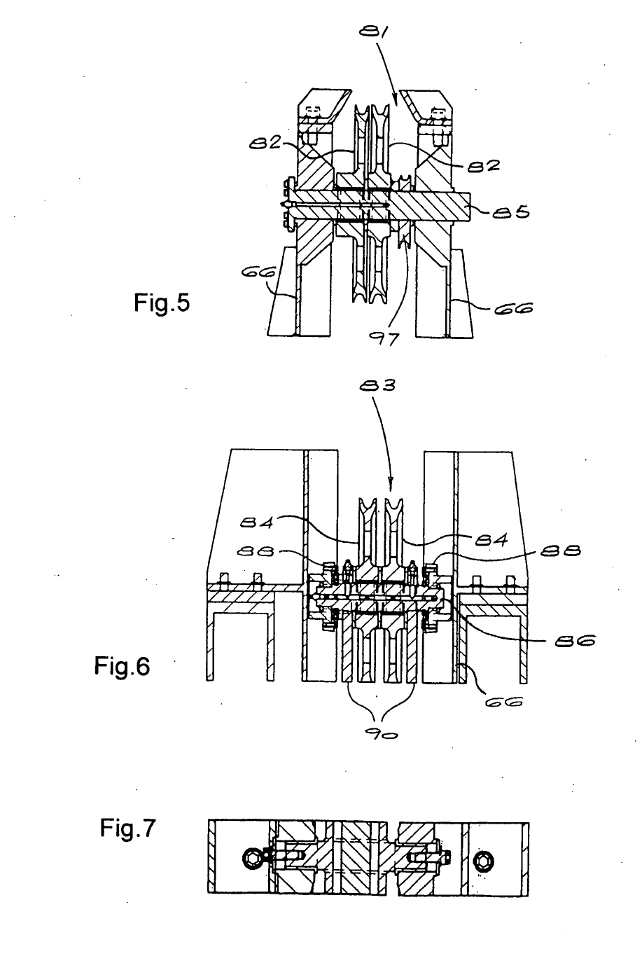

The apparatus 50 includes an upper pulley block 81 incorporating a pair of pulleys 82 which are supported for rotation, in a side by side relationship on a shaft 85, between the guide posts 66, as shown in FIG. 5. There is also a lower pulley block 83 incorporating a pair of pulleys 84 located in side by side relationship between the guide posts. In the lower pulley block the pulleys 84 are mounted on a shaft 86 spanning between rollers 88 which are capable of running vertically in the channel-section posts 66, as shown in FIG. 6. The shaft is carried by a clevis 90 connected to the upper end of the hydraulic actuator 68. The arrangement is such that extension of the actuator causes the lower pulley block 83 to move upwardly and retraction of the actuator causes the lower pulley block to move downwardly.

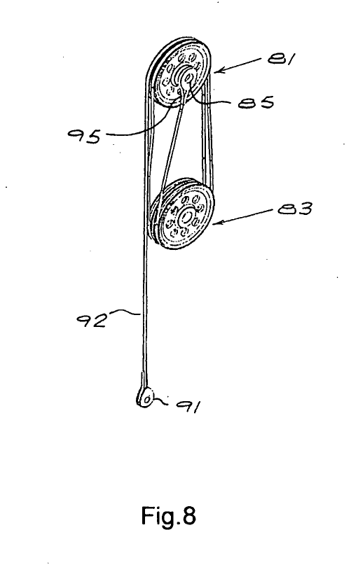

One end 91 of a cable 92 is connected to the mass 76 at a connection point 94. The cable passes over one pulley of the upper pulley block 81, then around one pulley of the lower pulley block, around the other pulley of the upper pulley block, around the other pulley of the lower block and finally extends upwardly to its other end 95 which is connected to the shaft 85 at a connection point 97. For clarity of illustration, the route followed by the cable is not shown in FIGS. 1 to 3 but is diagrammatically represented in FIG. 8.

Retraction of the actuator 68 pulls the lower pulley block 83 downwardly and accordingly raises the mass 76. FIGS. 1 to 3 show the mass at an elevated position caused by retraction of the actuator. As in the first embodiment, the mass is lifted at a mechanical disadvantage but a speed advantage. The arrangement of pulleys and cable results in a fourfold velocity advantage. Thus even if the retraction of the actuator takes place slowly, the mass can be raised quickly.

The second embodiment also includes a PLC (not shown) providing controls similar to those provided by the PLC 42 of the first embodiment. As in the first embodiment, once the mass 76 has been raised to a predetermined height under the control of the PLC, the actuator 68 is rapidly depressurized. The mass drops and applies an impact to the soil surface via the footplate 77. The process is repeated as necessary to achieve a desired level of soil compaction.

Also as in the first embodiment, the PLC may be interfaced with a GPS to correlate levels of soil compaction with geographical position.

In a non-illustrated modification of the second embodiment of FIGS. 2 to 8, an hydraulic actuator corresponding in function to the actuator 68 may be arranged to act downwardly rather than upwardly on the lower pulley block 83. In other words, extension of the actuator in this configuration will push the pulley block 83 downwardly rather than retraction of the actuator pulling it downwardly as in the illustrated configuration.

In yet another modification of the second embodiment, the upper pulley block 81 could be arranged as the floating or movable assembly and the lower pulley block as the fixed assembly. In this version, the hydraulic actuator will act on the pulley block 81 rather than the pulley block 83.

In other non-illustrated embodiments, the upper and lower pulley blocks could have more than two pulleys each with the cable passing alternatively around the pulleys in order to increase the mechanical disadvantage and velocity advantage of the apparatus compared to the illustrated apparatus in which the upper and lower pulley blocks have only a single pulley or two pulleys each.

Irrespective of which configuration of actuator and pulleys is used, a major advantage of each of the embodiments described above is the fact that the hydraulic or pneumatic actuator does not act directly on the mass. In each case, the cable and pulley system effectively isolates the actuator and associated supporting frame members from the impact shocks generated when the mass strikes the soil surface.

1. A drop mass soil compaction apparatus comprising a supporting frame, a mass which can be raised relative to the frame to an elevated position above a soil surface which is to be compacted, and mass lifting means for raising the mass to the elevated position such that when the mass is subsequently dropped from such position it impacts on the soil surface in order to compact it, wherein the mass lifting means comprising a flexible cable attached to the mass and an hydraulic or pneumatic actuator carried by the supporting frame and operable to act on the cable in a manner to raise the mass.

2. A drop mass soil compaction apparatus according to claim 1 wherein the cable acts to isolate the mass lifting mans from shock loads generated by impacts of the mass on the soil surface.

3. A drop mass soil compaction apparatus according to claim 1 wherein one end of the cable is anchored relative to the supporting frame and an opposite end of the cable is connected to the mass.

4. A drop mass soil compaction apparatus according to claim 3 wherein apparatus comprises respective pulley blocks each including one or more pulleys around which the cable passes, at least one of the pulley blocks, on which the actuator acts, being vertically movable.

5. A drop mass soil compaction apparatus according to claim 4 wherein the arrangement of cable and pulleys is such that the actuator acts at an mechanical disadvantage to raise the mass at a velocity advantage.

6. A drop mass soil compaction apparatus according to claim 5 comprising an upper pulley block and a lower pulley block, one of which is vertically movable and the other of which is vertically fixed, the actuator acting on the vertically movable pulley block.

7. A drop mass soil compaction apparatus according to claim 6 and including guide means for guiding vertical movements of the vertically movable pulley block.

8. A drop mass soil compaction apparatus according to claim 6 wherein each pulley block includes a single pulley.

9. A drop mass soil compaction apparatus according to claim 6 wherein each pulley block includes two pulleys or more pulleys arranged side by side.

10. A drop mass soil compaction apparatus according to claim 1 and comprising a PLC for controlling the actuator in order to achieve a predetermined level of compaction of the soil surface.

11. A drop mass soil compaction apparatus according to claim 10 wherein the PLC is interfaced with a GPS.

12. A drop mass soil compaction apparatus according to claim 1 and comprising mounting means for mounting the apparatus detachably to a vehicle.

13. A drop mass soil compaction apparatus according to claim 1 wherein the mass includes a footplate at its underside for applying impacts to the soil surface.

14. A drop mass soil compaction apparatus according to claim 1 and comprising a telescopic outrigger strut carrying a swiveling bearing plate at its lower end for bearing on the ground and stabilising the apparatus during compaction of the soil surface.
